(19) United States
(12) Patent Application Publication
(10) Pub. No.: US 2002/0082862 A1
(43) Pub. Date: Jun. 27, 2002

(54) Web-based medical diagnostic system financial operation planning system and method

(76) Inventors: Raymond J. Kelley, Waukesha, WI (US); Jack Oblein, Kenosha, WI (US); Mohsin S. Dawoodbhai, Waukesha, WI (US); David M. Oreshack, Delafield, WI (US); Christopher N. Japp, Milwaukee, WI (US); Douglas E. Stern, Waukesha, WI (US)

Correspondence Address: Patrick S. Yoder, Suite 330, 7915 FM 1960 West, Houston, TX, 77070, US

(21) Appl. No.: 09/747,041

(22) Filed: Dec. 22, 2000

(51) Int. Cl. G06F 17/60

(52) U.S. Cl. 705/2; 705/1

(57) ABSTRACT

The present technique is associated with projected financial analysis of a medical facility. The technique allows a client to interact with a remote financial analysis system via a network interface, and to enter and transmit client data for a medical facility to the financial analysis system for a projected financial analysis. Accordingly, the client receives a customized pro forma financial report for the medical facility.

### FIELD OF THE INVENTION

The present invention relates generally to financial analysis systems and, more particularly, to a technique for providing a projected financial analysis of a medical facility. The present technique permits data exchange between a financial analysis system and a remote interface via a network, allowing a client to interact with the financial analysis system and to receive a projected financial analysis report based on client data for the medical facility.

### BACKGROUND OF THE INVENTION

Medical institutions require various medical resources, such as real estate, human resources, medical systems, equipment and instruments, to provide healthcare services to patients. The medical resources employed at a particular medical institution greatly impact the efficiency, cost and revenue associated with a desired medical procedure. For example, a current system may allow a procedure to be completed in 20 minutes with 10 minutes of setup time, while another system may complete the procedure in 10 minutes with only 2 minutes of setup time. Less time means more procedures, and thus more revenue and lower patient waiting time for the procedures. As medical technology advances, particularly in the area of electronics and computer aided instruments, medical institutions must evaluate the feasibility of investing in new, additional or upgraded medical resources to better serve patients and become more efficient and profitable.

For example, medical diagnostic and imaging systems are ubiquitous in modem health care facilities. Such systems provide invaluable tools for identifying, diagnosing and treating physical conditions and greatly reduce the need for surgical diagnostic intervention. In many instances, final diagnosis and treatment proceed only after an attending physician or radiologist has complemented conventional examinations with detailed images of relevant areas and tissues via one or more imaging modalities.

Currently, a number of modalities exist for medical diagnostic and imaging systems. These include computed tomography (CT) systems, x-ray systems (including both conventional and digital or digitized imaging systems), magnetic resonance (MR) systems, positron emission tomography (PET) systems, ultrasound systems, nuclear medicine systems, and so forth. In many instances, these modalities complement one another and offer the physician a range of techniques for imaging particular types of tissue, organs, physiological systems, and so forth. Health care institutions often dispose of several such imaging systems at a single or multiple facilities, permitting its physicians to draw upon such resources as required by particular patient needs.

Modem medical diagnostic systems typically include circuitry for acquiring image data and for transforming the data into a useable form which is then processed to create a reconstructed image of features of interest within the patient. The image data acquisition and processing circuitry is often referred to as a “scanner” regardless of the modality, because some sort of physical or electronic scanning often occurs in the imaging process. The particular components of the system and related circuitry, of course, differ greatly between modalities due to their different physics and data processing requirements.

Medical diagnostic systems of the type described above are often called upon to produce reliable and understandable images within demanding schedules and over a considerable useful life. To ensure proper operation, the systems are serviced regularly by highly trained personnel who address imaging problems, configure and calibrate the systems, and perform periodic system checks and software updates. However, medical resources such as the above systems may become outdated, or relatively inefficient and costly compared to current medical systems. Accordingly, a medical institution may desire an upgraded medical system, or other new medical resources, such as medical products, systems and services offered by a medical resource supplier. If sufficient internal funds are available, the medical institution may simply purchase the desired medical resource with those funds. Alternatively, the medical institution may obtain third party financing (e.g., a term loan), financing from the seller (e.g., an installment loan), or leasing from the seller (e.g., an operating lease). Unfortunately, the seller may provide limited options for purchasing the desired medical resource, and may not readily provide a prospective purchaser (e.g., the medical institution) with such information. The seller may simply ignore the financial position of the prospective purchaser, and offer a standard transaction option not suitable or feasible for that purchaser.

Additionally, if the seller offers a standard lease option and a standard installment loan option, the prospective purchaser may not have access to a financial analysis system suitable for evaluating the lease and loan options. Furthermore, the financial systems currently available may not be suitable for analyzing financial data associated with medical institutions, and more particularly to investment transactions in medical resources. For example, medical institutions may have specific financial data (e.g., variable and fixed costs, revenues, deductions, etc.), which is significantly different from financial data associated with other fields and industries. Even within the medical field, the specific financial data may vary greatly from institution to institution.

Accordingly, there is a need for a technique for analyzing a desired medical resource investment for a medical institution based on financial data from the medical institution, and for providing a plurality of transaction options tailored to the financial data. More particularly, there is a need for a financial analysis system allowing interactive exchange of information, such as client data and transaction options, between a remote client interface and the financial analysis system via a network. There is also a need for a uniform media, such as the Internet, for accessing and communicating with the financial analysis system.

### SUMMARY OF THE INVENTION

The present technique is associated with financial analysis of a transaction for medical resources. The technique allows a client to interact with a remote financial analysis system via a network interface, and to enter and transmit client data for a medical facility to the financial analysis system for a projected financial analysis. Accordingly, the client receives a customized pro forma financial report for the medical facility to enhance financial planning, and to better serve the needs of the client.

According to one aspect of the present technique, a method may be provided for providing a financial outlook for a medical facility. The method comprises providing an electronic form having fields for entering financial data of the medical facility, electronically receiving the financial data from the electronic form via a network, and routing the financial data into a financial analysis system. The financial data comprises projected changes in at least a portion of the financial data over a future analysis period. Accordingly, a pro forma financial report is provided for the future analysis period based on the financial data. The method also may include electronically transmitting the pro forma financial report to a client via the network.

According to another aspect of the present technique, a system may be provided for generating projected financial statistics for a medical facility. The system comprises a client computer system for the medical facility, a financial analysis system remote from the medical facility, and a network for coupling the client computer system to the financial analysis system. The system also has an interface accessible on the client computer system via the network. The interface is configured to exchange client data with the financial analysis system. The financial analysis system is configured to evaluate the client data, which includes financial data relating to the medical facility, and to generate a projected financial report for the medical facility tailored to the client data.

### BRIEF DESCRIPTION OF THE DRAWINGS

The foregoing and other advantages of the invention will become apparent upon reading the following detailed description with reference to the drawings in which:

FIG. 1 is a diagram of the present technique, illustrating an exemplary system for communication and data exchange between a plurality of medical clients and a data processing center remote from the medical clients;

FIG. 2 is a diagram of the present technique, illustrating an exemplary embodiment of the data processing center and data exchange between the data processing center and a client;

FIG. 3 is an exemplary flow chart of the present technique, with reference to the network interface pages of FIGS. 4 and 5;

FIG. 4 is an exemplary query form for entering and transmitting client information from the client to the data processing center; and

FIG. 5 is an exemplary results page for textually and graphically displaying pro forma financial analysis results received by the client from the data processing center.

### DETAILED DESCRIPTION OF THE INVENTION

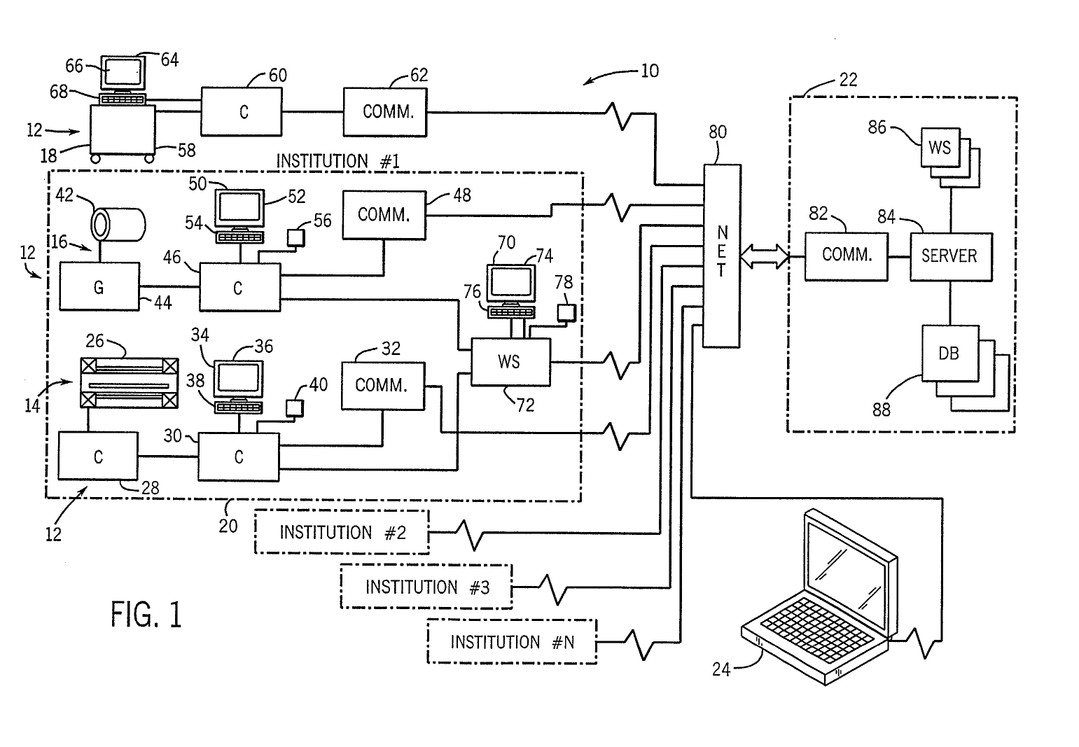

Turning now to the drawings, and referring first to FIG. 1, a communication system 10 is illustrated for providing remote data processing for a plurality of healthcare providers having a plurality of medical resources, such as medical diagnostic systems 12. In the embodiment illustrated in FIG. 1, the medical diagnostic systems 12 include a magnetic resonance imaging (MRI) system 14, a computed tomography (CT) system 16, and an ultrasound imaging system 18. The diagnostic systems 12 may be positioned in a single location or facility, such as institutions #1, #2, #3 and #N (e.g., medical facility 20), or may be remote from one another as illustrated for ultrasound imaging system 18. Each medical facility also may gain remote access to a data processing center 22 via the communication system 10. The data processing center 22 is also accessible via a remote client unit 24. Accordingly, multiple client workstations and medical institutions with various modalities have access to the data processing center 22.

In the exemplary embodiment of FIG. 1, several different medical clients (e.g., institutions #1, #2, #3 and #N) are provided with remote access to the data processing center 22. These and other medical clients may be provided access to, and benefit from, the data processing center 22, depending upon the capabilities of the data processing center 22, and other factors. However, the present technique is particularly well suited for remotely processing client data associated with a wide variety of medical diagnostic system modalities, including MRI systems, CT systems, ultrasound systems, positron emission tomography (PET) systems, nuclear medicine systems, and so forth. Moreover, the medical clients utilizing the data processing center 22 in accordance with the present techniques may be in different medical fields, may have different medical resources, and may have different types of patients. For example, medical resources may include a variety of medical equipment, systems, instruments and human resources for a particular medical procedure or medical practice. Furthermore, medical resources may include real estate, office space, healthcare service capacity, and financial resources of a particular institution. A variety of client data may be transmitted to the data processing center 22 via the communication system 10. For example, the client may transmit data from the medical diagnostic systems, data files from a computer, or data may be entered from a client computer coupled to the communication system 10 (e.g., remote client unit 24). The client data may comprise a variety of information associated with the client, the particular medical institution, and with the medical resources available to the particular medical institution. For example, the client data may comprise past and projected financial data/statistics, operational data/statistics, medical resources used or desired by the client, patient information, and other relevant client data from past operations or future projections.

The medical resources, as noted above, may comprise a variety of medical systems. Depending upon the modality of the systems, various subcomponents or subsystems will be included. In the case of MRI system 14, such systems will generally include a scanner 26 for generating pulsed magnetic fields and for collecting signals from emissions by gyromagnetic material within a subject of interest. The scanner is coupled to a control and signal detection circuit 28 which, in turn, is coupled to a system controller 30. The system controller 30 includes a uniform platform for interactively exchanging client data and processing requests with data processing center 22, as described more fully below. The system controller 30 is linked to a communications module 32, which may be included in a single or separate physical package from system controller 30. System controller 30 is also linked to an operator station 34, which will typically include a computer monitor 36, a keyboard 38, as well as other input devices 40, such as a mouse. In a typical system, additional components may be included in system 14, such as a printer or photographic system for producing reconstructed images based upon data collected from scanner 14. Although reference is made herein generally to “scanners” in diagnostic systems, that term should be understood to include medical diagnostic data acquisition equipment generally. Accordingly, it should not be limited to image data acquisition, to picture archiving communications and retrieval systems, nor to image management systems, facility or institution management systems, viewing systems and the like, in the field of medical diagnostics. More particularly, the medical resources may include imaging systems, clinical diagnostic systems, physiological monitoring systems, and so forth.

Similarly, CT system 16 will typically include a scanner 42, which detects portions of x-ray radiation directed through a subject of interest. Scanner 42 is coupled to a generator and controller, as well as to a signal acquisition unit, represented collectively at reference numeral 44, for controlling operation of an x-ray source and gantry within scanner 42, and for receiving signals produced by a detector array moveable within the scanner. The circuitry within the controller and signal acquisition components is coupled to a system controller 46 which, like controller 30 mentioned above, includes circuitry for commanding operation of the scanner and for processing and reconstructing image data based upon the acquired signals. System controller 46 is linked to a communications module 48, generally similar to communications module 32 of MRI system 14, for transmitting and receiving data for processing at the data processing center 22. Also, the system controller 46 is coupled to an operator station 50, which includes a computer monitor 52, a keyboard 54, as well as other input devices 56, such as a mouse. Moreover, like MRI system 14, CT system 16 will generally include a printer or similar device for outputting reconstructed images based upon data collected by scanner 42.

Other modality devices will include circuitry and hardware particularly configured for acquiring or producing signals in accordance with their particular design. In particular, in the case of ultrasound system 18, such systems will generally include a scanner and data processing unit 58 for transmitting ultrasound signals into a subject of interest, and for acquiring resultant signals which are processed for reconstructing a useful image. The system includes a system controller 60 which regulates operation of scanner 58 and which processes acquired signals to reconstruct the image. Moreover, system 18 includes a communications module 62 for transmitting client data and processing requests between system controller 60 and the data processing center 22. System 18 also includes an operators station 64, including a monitor 66, as well as input devices such as a keyboard 68.

Where more than one medical diagnostic system is provided in a single facility or location, as indicated in the case of MRI and CT systems 14 and 16 in FIG. 1, these may be coupled to a management station 70, such as in a radiology department of a hospital or clinic. The management station may be linked directly to controllers for the various diagnostic systems, such as controllers 30 and 46 in the illustrated embodiment. The management system may include a computer workstation or personal computer 72 coupled to the system controllers in an Intranet configuration, in a file sharing configuration, a client/server arrangement, or in any other suitable manner. Moreover, management station 70 will typically include a monitor 74 for viewing system operational parameters, analyzing system utilization, and exchanging client data and processing information between the facility 20 and the data processing center 22. Input devices, such as a standard computer keyboard 76 and mouse 78, may also be provided to facilitate the user interface. It should be noted that, alternatively, the management system, or other diagnostic system components, may be “stand-alone” or not coupled directly to a diagnostic system. Although the data processing center 22 may require a variety of client data to fully process a client request, the client data may not include medical system data derived directly from the medical system (e.g., CT and MRI systems). The client data may simply be transmitted from a client computer (e.g., remote client unit 24) after having been entered by the medical client. For example, the client data may be entered via an electronic form, or web interface.

The communication modules mentioned above, as well as workstation 72 and remote client unit 24, may be linked to data processing center 22 via a remote access network 80. For this purpose, any suitable network connection may be employed. Presently preferred network configurations include both proprietary or dedicated networks, as well as open networks, such as the Internet. Data may be exchanged between the institutions, medical resources, client computers and the remote data processing center 22 in any suitable format, such as in accordance with the Internet Protocol (IP), the Transmission Control Protocol (TCP), or other known protocols. Moreover, certain portions of the data may be transmitted or formatted via markup languages such as the HyperText Markup Language (HTML), Extensible Markup Language (XML), or other Internet and communication languages. Exemplary interface structures and communications components are described in detail below.

Within the data processing center 22, messages, client requests and client data are received by communication components as indicated generally at reference numeral 82. The communication components 82 direct the client data to a server, or a processing system 84, for the receipt, handling and processing of client data. In general, processing system 84 may include one or a plurality of computers, as well as dedicated hardware or software servers for processing the various requests and for receiving and transmitting the information as described more fully below. The data processing center 22 also may include a bank of workstations 86, which may be staffed by operators who address the processing requests and provide off and on-line assistance in response to the processing requests. Also, the processing system 84 may be linked to a set of databases or other processing systems 88 at or remote from the data processing center 22. Such databases and processing systems may include extensive database information on medical resources (e.g., medical systems), a particular medical facility, and so forth. As described below, such databases may be employed both for analyzing the client data and for processing the request transmitted by the client.

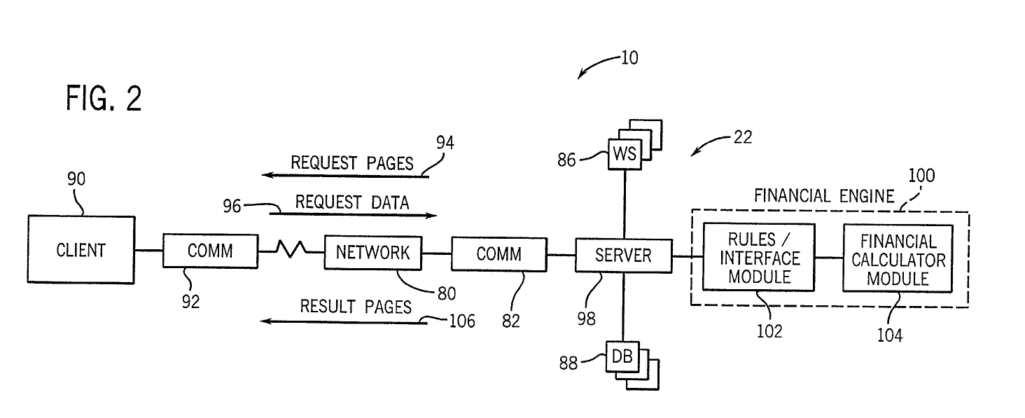

FIG. 2 is a diagram of the communication system 10, illustrating an exemplary embodiment of the data processing center 22 accessible by a client 90. The client 90 may be a medical facility, institution or individual interested in medical resources. The data processing center 22 may be associated with a medical supplier, a medical institution, or some other entity located remote from the client 90. For example, the data processing center 22 may be associated with a financial consulting firm, or some other financial analysis entity. The client 90 can communicate with the data processing center 22 via a communication device 92, which connects to the network 80 and the communication components 82 for the data processing center 22. The communication device 92 may be a modem or some other network device, allowing the client 90 to connect to the network 80 with a client computer system (e.g., remote client unit 24). The client 90 may access the network 80 via the Internet or other suitable network connections, thus the network 80 can be broadly interpreted to comprise all necessary networking between the client 90 and the data processing center 22.

In this exemplary embodiment, the client 90 electronically receives request pages 94 (e.g., data entry forms) from the data processing center 22, or an applications server for the network (e.g., Internet). For example, the client 90 may go to a web site having the request pages. The client 90 enters data, makes appropriate selections, and transmits a processing request to the data processing center 22. Accordingly, request data 96 is routed through the network 80 and to the data processing center 22. The request data 96 may comprise a variety of client data, as discussed above. The request data 96 is received by a server, or processing system 98, which handles the request, interprets and evaluates the request data, and provides a data analysis based on the request data. The processing system 98 may include a plurality of computer systems, servers, workstations 86, databases 88, and other hardware and software applications necessary for processing the request data.

In this exemplary embodiment, the processing system 98 has a financial engine 100 for financially analyzing the request data, and for generating a financial analysis tailored to the request data from the client. The financial engine 100 may be a remote analysis system, accessible by the processing system 98, or it may be an integral part of the processing system 98. The financial engine 100 has a rules and interface module 102 and a financial calculator module 104, which jointly work to provide a customized financial analysis for the client 90 based on the request data 96.

The rules and interface module 102 comprises rules for financially analyzing the request data, including tax rules and other considerations for the medical field. Accordingly, the rules and interface module 102 adapts the financial calculator module 104 to the desired industry or field, such as medical resources. For example, the medical field may be subject to specific taxes, laws, regulations, and various accounting and/or financial practices unlike other fields. By providing such rules, the financial calculations are customized for the medical field, enabling the financial engine 100 to more accurately analyze the client request data. Alternatively, the rules and interface module 102 may simply comprise an interface for procuring communication between the processing system 98 and the financial engine 100, particularly where the two systems are remote from one another or require translation from one system to the other (e.g., different software or communication protocols).

After analyzing the request data, the financial engine 100 provides a financial analysis tailored to the request data. Result pages 106 are then transmitted to the client 90 via the communication system 10, either directly from the financial engine 100 or after further processing by the processing system 98. For example, the processing system 98 may generate user viewable pages (e.g., Internet pages) based on the financial analysis. The client may then view the result pages via a network interface, which may comprise a client computer system having an Internet browser or other appropriate software.

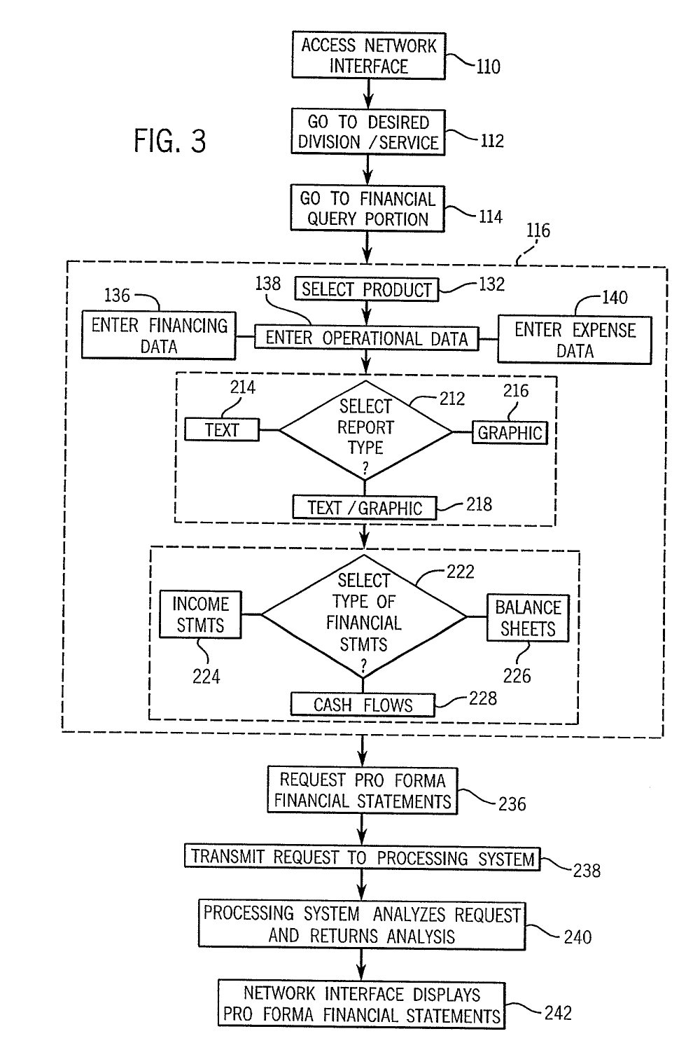

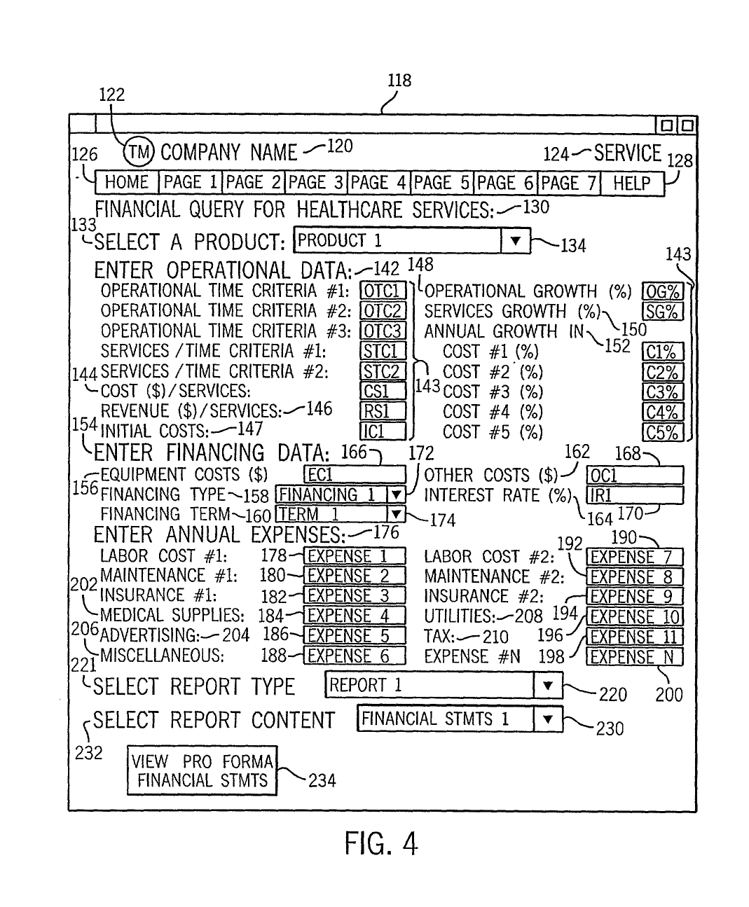

FIG. 3 is a flow chart of the present technique, illustrating communication and data exchange between the client 90 and the data processing center 22 remote from the client 90. To communicate with the data processing center 22, the client 90 accesses the network interface 110, which may include a variety of hardware and software such as a server, a client computer system and communication software. In this exemplary embodiment, the network interface comprises an electronic form, such as illustrated in FIG. 4, allowing the client 90 to enter and transmit client data to the data processing center 22. For example, the network interface may be configured to access and display an Internet site (e.g., a website) requiring the client 90 to gain access to the website to view and browse the electronic forms. Accordingly, the network interface may comprise an Internet browser (e.g., Netscape or MS Internet Explorer) or other suitable software for displaying the electronic forms, provided that it allows the client 90 to transmit client data to the data processing center 22. Once the client 90 has access to the network interface, which may require a password and other login information, the client 90 may go to or browse to the desired division or service 112 displayable via the network interface. For example, if the network interface comprises an Internet website, the client 90 may browse the website and go to a page displaying the desired division or service 112. The division or service may be a financial service, a productivity service, or it may be a service associated with a particular medical resource. The client 90 then browses to or goes to a financial query portion 114, such as query portion 116, of the electronic forms corresponding to that division or service, where a variety of questions are provided regarding the client 90 and the medical facility and/or resources associated with the client 90. FIG. 4 illustrates an exemplary query form 118, as discussed below.

In the present technique, the questions on the query form 118 are tailored to obtain a variety of client data, which may be relevant to a financial analysis of medical resources and/or healthcare services associated with a particular medical resource (e.g., medical product or system). Accordingly, the electronic forms may inquire into various matters that may impact revenues, costs & expenses, and into other factors that may be relevant to a financial analysis of a medical facility or a particular medical resource of the client 90. For example, as described below, the query form 118 may inquire into fixed and variable costs and revenues, financing of medical resources, and projected growth or changes in those costs and revenues. Furthermore, the query form 118 may be tailored to the client 90, or it may allow the client 90 to enter client specific categories and data, rather than the healthcare categories illustrated in FIG. 4. In one aspect, the present technique comprises a financial analysis tool, which may be utilized by the client 90 to obtain a customized financial analysis based on the client data. An exemplary embodiment of this financial analysis tool utilizes the Internet, and provides an Internet based financial analysis tool for medical clients to evaluate their operations and a particular medical resource, which may be desired by the medical client and provided by the entity hosting the financial analysis tool.

Referring now to FIG. 4, the query form 118 is provided for entering and transmitting client data to the data processing center 22. As illustrated, the query form 118 provides a company name 120, a trademark 122 for the company name 120, and a service area 124 as selected above 112. The query form 118 also may have a series of buttons or links to other pages such as home 126, page 1, page 2, page 3, page 4, page 5, page 6, page 7, or help page 128. The query form 118 also may have a title such as “Financial Query For Healthcare Services” 130. The query portion 116 of the query form 118 allows the client 90 to enter a plurality of client data into data entry fields, such as drop-down menus and text boxes. For example, the query form 118 may ask the client 90 to select a particular product 132 for analysis with the data processing center 22. In a product selection portion 133, a drop-down menu 134 is provided for the client 90 to select a medical resource, such as product 1, from a list of medical resources (e.g., medical products and systems). The query form 118 may also provide other fields for data entry, and may request the client 90 to enter financing data 136, to enter operational data 138, and/or to enter expense data 140.

Under a heading Enter Operational Data 142, the query form 118 provides data entry fields 143 (e.g., text boxes) for entering an operational time criteria #1, #2, and #3, a services/time criteria #1 and #2, a cost per services 144, a revenue per services 146, an initial cost 147, an operational growth percentage 148, a services growth percentage 150, and an annual growth in a cost #1, #2, #3, #4, and #5. As illustrated, the client 90 may enter values for those criteria, such as OTC1, OTC2, OTC3, STC1, STC2, CS1, RS1, IC1, OG %, SG %, C1%, C2%, C3%, C4%, and C5%, respectively. The query form 118 also has a query portion 116, entitled Enter Financing Data 144, which has a plurality of data entry fields for entering an equipment cost 156, a financing type 158, a financing term 160, other costs 162, and an interest rate 164. Accordingly, text boxes 166, 168, and 170 are provided for queries into the equipment costs 156, the other costs 162, and the interest rate 164, allowing the client 90 to enter values such as EC1, OC1, and IR1, respectively. Drop-down menus 172 and 174 are provided for queries into the financing type 158 and the financing term 160, allowing the client to select a financing 1 and a term 1, respectively. The query form 118 also provides a query portion 116, entitled Enter Annual Expenses 176. In this query portion 116, text boxes 178, 180, 182, 184, 186, 188, 190, 192, 194, 196, 198, and 200 are provided for entering annual expenses such as EXPENSE 1 through EXPENSE N corresponding to queries for a labor cost #1, a maintenance cost #1, an insurance cost #1, medical supplies 202, advertising costs 204, miscellaneous expenses 206, a labor cost #2, a maintenance cost #2, an insurance cost #2, a utility cost 208, a tax 210, and an expense N, respectively.

Although specific examples are provided on this query form 118, the present technique may inquire into a variety of other costs, expenses, and operational data corresponding to operations and medical resources for the particular client 90. The query form 118 may also allow the client 90 to select a report type 212, such as a text format 214, a graphic format 216, or a combination text and graphic format 218. Accordingly, a drop-down menu 220 is provided adjacent to a section 221, entitled Select Report Type, for the client 90 to select a type of report, such as REPORT 1, from a list of available report types. The query form 118 may also have a query portion 116 allowing the client 90 to select a type of financial statement 222, such as income statements 224, balance sheets 226, and/or cash flow statements 228. On the query form 118, a drop-down menu 230 is provided for a query portion entitled Select Report Content 232, allowing the client 90 to select a type of financial statement such as FINANCIAL STMTS 1. Thus, the present technique is configured to provide the client 90 a customized financial analysis in terms of the client data being analyzed by the data processing center 22, and it allows the client 90 to tailor the financial report, which is based on the financial analysis, to the particular financial criteria and format desired by the client 90. For example, the client 90 may obtain a variety of financial statement as noted above, and also a variety of financial summaries, projections, financial indicators, and special financial analysis reports (e.g., present value analysis).

Once the client 90 has completed the query form 118, the client 90 may click a “View Pro Forma Financial Statements” button 234 to request pro forma financial statements 236. By depressing the button 234, the client 90 transmits the request and corresponding client data to the processing system 238 (e.g. the data processing center 22). The processing system then analyzes the request and corresponding client data and returns an analysis to the network interface 240. As noted above, the processing system provides a financial analysis tailored to the client data, providing the client 90 a more accurate and detailed financial outlook for the particular client and medical facility. The financial engine 100 may utilize a plurality of mathematical software applications to financially analyze the client data, and may have one or more of the rules interface modules 102. For example, the financial engine 100 may comprise a spreadsheet for laying out and analyzing the client data, a statistics program for statistically analyzing the client data, a graphics program for plotting the client data, and a web page development application for producing web pages from the client data analyzed by the data processing center 22. The rules interface module 102 also may have a tax module, a time value of money module (e.g., for evaluating a present value of cash flows), and/or a healthcare/medical module (e.g., having rules particular to the medical field or the particular client 90). Once the financial engine 100 has analyzed the client data, the financial analysis is transmitted to the network interface in the form of unformatted or formatted data, such as a comma delimited file or an Internet formatted document (e.g., html). The network interface then displays pro forma financial statements 242 corresponding to the financial analysis provided by the processing system 240. The type of financial statements displayed corresponds to those selected in the query portion above 222. Other financial analysis information also may be provided on the network interface, such as one or more financial analysis summaries.

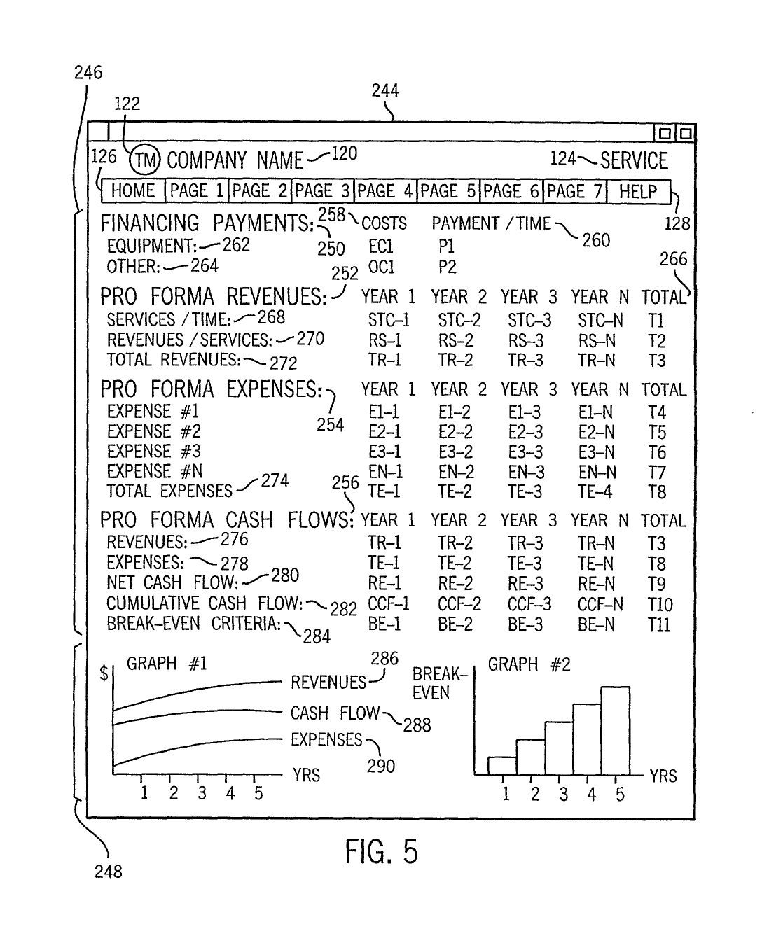

Referring now to FIG. 5, a results page 244 is provided for displaying the financial analysis received from the processing system 240. As illustrated, the results page 240 is a text/graphic type 218, having a text portion 246 and a graphic portion 248. In the text portion 246, the results page 244 has headings of Financing Payments 250, Pro Forma Revenues 252, Pro Forma Expenses 254, and Pro Forma Cash Flows 256. In the graphic portion 248, the results page 244 displays a graph number 1 and a graph number 2, wherein graph #1 is a line graph and graph #2 is a bar chart. Under the heading Financing Payments 250, the results page 244 displays costs 258 of EC1 and OC1 and payment per time 260 of P1 and P2, corresponding to equipment 262 and other 264, respectively. While specific examples are given, the financing payments section 250 may comprise a variety of other information associated with financing medical resources for the client 90, such as interest rates, financing periods and amounts, tax impacts, and other criteria.

Under the heading Pro Forma Revenues 252, the results page 244 provides projected revenues over years 1, 2, 3, and N, as well as a total 266. For example, projected revenues for services per time 268 are STC-1, STC-2, STC-3, and STC-N with a total of T1. Revenues per services 270 have projected revenues of RS-1, RS2, RS-3, and RS-N with a total of T2. Total revenues 272 are projected to be TR-1, TR-2, TR-3, and TR-N with a total of T3. Although a limited amount of revenue information is provided in the pro forma revenues section 252, the results page 244 may provide detailed categories and subcategories to allow the client 90 a more detailed breakdown of the projected revenues. For example, projected revenues may comprise categories of healthcare procedures per day, days of operation per week, weeks of operation per year, billing charges for each procedure, total billings for the procedures, uncollectibles (e.g., unpaid debts), and a variety of other categories associated with the medical resource selected in drop down menu 134.

Under the heading Pro Forma Expenses 254, the results page 244 provides projected expenses #1, #2, #3, and #N and total expenses 274 for years 1, 2, 3, and N, as well as the total 266 of the projected expenses over the years 1 through N. As illustrated, expense #1 has projected values of E1-1, E1-2, E1-3, and E1-N with a total T4. Expense #2 has projected values of E2-1, E2-2, E2-3, and E2-N with a total T5. Expense #3 has projected values of E3-1, E3-2, E3-3, and E3-N with a total T6. Expense #N has projected values of EN-1, EN-2. EN-3, and EN-N with a total T7. The total expenses 274 are projected to be TE-1, TE-2, TE-3, and TE-4, with a total of the yearly totals to be T8. Similar to the revenues discussed above, the projected expenses are illustrated as generic categories, which may comprise a variety of expenses such as inventory costs, start up costs, employee wages and expenses, equipment leases and maintenance, real estate costs, building costs and rent, utilities, insurance costs, medical resource supplies, management costs, miscellaneous costs, taxes, office expenses, advertising and marketing, dues and subscriptions, travel expenses, and various other expenses depending on the particular client, medical field and facility of the client 90.

Under the heading Pro Forma Cash Flows 256, the results page 244 provides projected cash flows for multiple categories over years 1, 2, 3, and N, as well as a total for the years 1 through N. For example, projected cash flows of TR-1 through TR-N, TE-1 through TE-N, RE-1 through RE-N, CCF-1 through CCF-N, and BE-1 through BE-N are provided for revenues 276, expenses 278, net cash flows 280, cumulative cash flows 282, and for a break even criteria 284 over years 1 through N. Totals of T3, T8, T9, T10, and T11 are also provided for the pro forma cash flow categories 276, 278, 280, 282, and 284, respectively. Again, the illustrated categories are somewhat generic, and may comprise a variety of more detailed categories and subcategories tailored to the client 90, the medical resources and the medical facility of the client 90.

Turning now to the graph portion 248, graph #1 illustrates revenues 286, cash flows 288, and expenses 290 over the years 1, 2, 3, 4, and 5. In graph number 2, the break even criteria 284 is illustrated graphically over the years 1, 2, 3, 4, and 5. Although the results page 244 displays specific types of payments, revenues, expenses, cash flows, and graphs, the results page 244 is not limited to these types of criteria and graphic displays. A variety of financial criteria may be graphically or textually illustrated on the results page 244, and may vary according to the medical resource and financial analysis received from the data processing center 22.

According to the embodiments illustrated in FIGS. 1-5, the present technique provides an exemplary method for financially analyzing client data associated with a particular medical resource, and for providing a projected financial analysis of a medical facility utilizing the particular medical resource for healthcare services. The present technique may also provide a financial control method for the client to react to projected financials, and correct potential financial problems. Accordingly, the method may comprise providing a financial outlook for a medical facility by providing an electronic form having fields for entering financial data of the medical facility, electronically receiving the financial data from the electronic form via a network, routing the financial data into a financial analysis system, generating a pro forma financial report for a future analysis period tailored to the financial data, and electronically transmitting the pro forma financial report to a client via the network.

The method may also involve identifying the client and tailoring the electronic form to the client (e.g., through a login and password, and a client profile stored for the client 90). A network interface (e.g., a client computer system, a server, communication software and hardware, etc.) also may be provided for communication between the financial analysis system and the client 90. Moreover, the electronic form may be provided with one or more data entry fields (e.g., drop down menus and text boxes) for entering the client data, allowing the client to transmit the client data to the financial analysis system. For example, the data entry fields and client data may comprise projected changes in at least a portion of the financial data over a future analysis period, a desired healthcare category, a desired medical system, fixed and/or variable costs of operating the medical facility, a projected growth of an operating cost and/or revenue, a wage statistic (e.g., salary, bonuses, benefits, insurance, etc.) for employees of the medical facility, a medical supply cost for the medical facility, a medical equipment cost for the medical facility, a tax statistic (e.g., property tax, income tax, etc.), an overhead cost for the medical facility, a medical procedure volume per time period, a service charge per medical procedure, a revenue statistic and a projected growth for a medical procedure (e.g., associated with a particular medical system), a revenue deduction, a financing statistic for the medical facility (e.g., a financed medical resource, monetary amount, period and interest rate for the financing), and a desired report type and content.

The method also may comprise providing a set of financial rules (e.g., tax rules, accounting practices, etc.) for analyzing the financial data with the financial analysis system. The financial data may be electronically receiving the financial data via the Internet or other network connections, and may be analyzed by one or more applications/systems of the financial analysis system. The present technique also may comprise evaluating tax consequences (e.g., property taxes, income taxes, etc.), evaluating a time value of money, and/or evaluating the financial data for a desired operating period of the medical facility. Also, the method may comprise displaying the pro forma financial report on the network interface via a web browser, or other suitable software depending on the format of the data.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A method for providing a financial outlook for a medical facility, the method comprising:
providing an electronic form having fields for entering financial data of the medical facility associated with at least one of a plurality of modalities, the financial data comprising projected changes in at least a portion of the financial data over a future analysis period;
electronically receiving the financial data from the electronic form via a network;
routing the financial data into a financial analysis system;
generating a pro forma financial report for the future analysis period tailored to the financial data; and
electronically transmitting the pro forma financial report to a client via the network.

2. The method of claim 1, comprising identifying the client and tailoring the electronic form to the client.

3. The method of claim 1, wherein providing an electronic form having fields comprises allowing the client to select a desired healthcare category.

4. The method of claim 1, wherein providing an electronic form having fields comprises allowing the client to select a desired medical system from a plurality of medical systems.

5. The method of claim 1, wherein providing an electronic form having fields comprises allowing data entry of a fixed cost of operating the medical facility.

6. The method of claim 1, wherein providing an electronic form having fields comprises allowing data entry of a variable cost of operating the medical facility.

7. The method of claim 1, wherein providing an electronic form having fields comprises allowing data entry of a projected growth of a cost of operating the medical facility.

8. The method of claim 1, wherein providing an electronic form having fields comprises allowing data entry of a wage statistic for employees of the medical facility.

9. The method of claim 1, wherein providing an electronic form having fields comprises allowing data entry of an indirect labor statistic for employees of the medical facility.

10. The method of claim 1, wherein providing an electronic form having fields comprises allowing data entry of a medical supply cost for the medical facility.

11. The method of claim 1, wherein providing an electronic form having fields comprises allowing data entry of a medical equipment cost for the medical facility.

12. The method of claim 1, wherein providing an electronic form having fields comprises allowing data entry of a tax statistic for the medical facility.

13. The method of claim 1, wherein providing an electronic form having fields comprises allowing data entry of an overhead cost for the medical facility.

14. The method of claim 1, wherein providing an electronic form having fields comprises allowing data entry of a medical procedure volume per time period.

15. The method of claim 1, wherein providing an electronic form having fields comprises allowing data entry of a service charge per medical procedure provided by the medical facility.

16. The method of claim 1, comprising allowing data entry of a financing amount, interest rate and financing period for a financed medical resource for the medical facility.

17. The method of claim 1, comprising providing a set of financial rules for analyzing the financial data with the financial analysis system.

18. The method of claim 1, wherein electronically receiving comprises electronically receiving the financial data via the Internet.

19. A system for generating projected financial statistics for a medical facility, the system comprising:
a client computer system for the medical facility;
a financial analysis system remote from the medical facility;
a network for coupling the client computer system to the financial analysis system; and
an interface accessible on the client computer system via the network, wherein the interface is configured to exchange client data with the financial analysis system, the client data comprising financial data relating to the medical facility, and wherein the financial analysis system is configured to evaluate the client data and to generate a projected financial report for the medical facility tailored to the client data.

20. The system of claim 19, wherein the financial analysis system comprises a financial rule module.

21. The system of claim 19, wherein the financial analysis system comprises a tax module having rules for evaluating tax effects on the financial data.

22. The system of claim 19, wherein the financial analysis system comprises a healthcare module having rules for financially evaluating operations of a healthcare provider, such as the medical facility.

23. The system of claim 19, wherein the network comprises the Internet.

24. The system of claim 19, wherein the interface comprises a form configured for entering and transmitting the client data to the financial analysis system.

25. The system of claim 19, wherein the interface comprises a data entry field for a desired healthcare category.

26. The system of claim 19, wherein the interface comprises a data entry field for a desired medical system associated with at least one of a plurality of modalities.

27. The system of claim 19, wherein the interface comprises a data entry field for a medical supply cost for the medical facility.

28. The system of claim 19, wherein the interface comprises a data entry field for a medical equipment cost for the medical facility.

29. The system of claim 19, wherein the interface comprises a data entry field for a medical procedure volume per time period.

30. The system of claim 19, wherein the interface comprises a data entry field for a service charge per medical procedure provided by the medical facility.

31. The system of claim 19, wherein the interface comprises a data entry field for a selection of a medical system associated with a revenue statistic and a projected growth.

32. The system of claim 19, wherein the interface comprises a data entry field for an equipment cost being financed for the medical facility.

33. The system of claim 19, wherein the interface comprises a data entry field for a financing amount, interest rate and financing period for a financed medical resource for the medical facility.

34. A method for analyzing finances of a healthcare facility, the method comprising:
providing an interface having a form for entering client data relating to the healthcare facility, wherein the client data comprises a healthcare category and financial data including projected changes in at least a portion of the financial data;
electronically accepting the financial data from the interface at a financial analysis system via a network;
financially analyzing and projecting at least a portion of the financial data over a future outlook period via the financial analysis system; and
returning a pro forma financial report to a client via the network.

35. The method of claim 34, comprising identifying the client and tailoring the form to the client.

36. The method of claim 34, comprising tailoring the form to the healthcare category, wherein the healthcare category is associated with at least one of a plurality of modalities.

37. The method of claim 34, wherein providing the interface comprises providing a server for exchanging information between the financial analysis system and a client computer system for the healthcare facility.

38. The method of claim 34, wherein providing the interface comprises providing a field for entering a medical supply cost for the healthcare facility.

39. The method of claim 34, wherein providing the interface comprises providing a field for entering a medical equipment cost for the healthcare facility.

40. The method of claim 34, wherein providing the interface comprises providing a field for entering a medical procedure revenue statistic.

41. The method of claim 40, comprising providing a field for entering a projected growth for the medical procedure revenue statistic.

42. The method of claim 34, wherein electronically accepting comprises electronically accepting the financial data via the Internet.

43. An Internet financial analysis system for financially evaluating a healthcare facility, the system comprising:
a client computer system for the healthcare facility;
a financial analysis system remote from the healthcare facility;
a network for exchanging data between the client computer system and the financial analysis system;
an Internet query form having a plurality of data entry fields configured for accepting financial data of the healthcare facility, the Internet form being accessible on the client computer system and having a healthcare procedure field for entering a revenue statistic of a healthcare procedure; and
an Internet results page for displaying a projected financial statistic from the financial analysis system.

44. The system of claim 43, wherein the financial analysis system comprises a healthcare module having rules for financially evaluating operations of a healthcare provider.

45. The system of claim 43, comprising an interface for viewing the Internet query form and the Internet results page, and for communicating between the client computer system and the financial analysis system.

46. The system of claim 45, comprising an identification system configured for identifying a client and tailoring the interface to the client.

47. The system of claim 43, wherein the plurality of data entry fields comprise a field for selecting a desired medical system for at least one of a plurality of modalities.

48. The system of claim 43, wherein the plurality of data entry fields comprise a field for a projected growth of a cost of operating the healthcare facility.

49. The system of claim 43, wherein the plurality of data entry fields comprise a field for a projected growth for the healthcare procedure.

50. The system of claim 43, wherein the plurality of data entry fields comprise fields for a financing amount, interest rate and financing period for a financed medical resource for the healthcare facility.
